(19) United States
(12) Patent Application Publication
(10) Pub. No.: US 2024/0335079 A1
(43) Pub. Date: Oct. 10, 2024

(54) MOBILE ROBOT, DOCKING STATION, AND ROBOT SYSTEM HAVING SAME

(71) Applicant: LG ELECTRONICS INC., Seoul (KR)

(72) Inventors: Dongseong KIM, Seoul (KR); Heegu PARK, Seoul (KR); Jaeheon CHUNG, Seoul (KR)

(21) Appl. No.: 18/578,050

(22) PCT Filed: Jul. 21, 2021
(86) PCT No.: PCT/KR2021/009415

§ 371 Date: Jan. 10, 2024

(30) Foreign Application Priority Data
Jul. 14, 2021 (KR) 10-2021-0092291

(51) Int. Cl. A47L 11/40; H04B 3/54

(52) U.S. Cl. CPC A47L 11/4011; A47L 11/4008; H04B 3/54; A47L 2201/02; A47L 2201/04

(57) ABSTRACT

A robot system according to an aspect of the present disclosure may comprise: a plurality of mobile robots; a plurality of docking stations; and a server that assigns identification information and a docking signal dispatch time to a plurality of registered docking stations, and transmits docking signal information including the identification information and the docking signal dispatch time to the plurality of mobile robots corresponding to each of the plurality of docking stations.

### TECHNICAL FIELD

The present disclosure relates to a mobile robot, a docking station, and a robot system including the same, and more particularly, to a robot system including a plurality of docking stations.

### BACKGROUND ART

Robots have been developed for industrial use and have been responsible for part of factory automation. Recently, the field of application of robots has further expanded, and thus medical robots, aerospace robots, and the like have been developed and household robots that can be used in general homes have also been produced. Among such robots, a robot that can travel by itself is called a mobile robot.

A representative example of a mobile robot used at home is a robot vacuum cleaner, which is a device that cleans a certain area by traveling by itself and sucking in surrounding dust or foreign substances.

A mobile robot autonomously travels using power stored in a battery. A mobile robot can return to a docking station after traveling and charge the battery thereof. A mobile robot returns to recharge the battery for continuous autonomous traveling. In this case, the docking station can transmit a signal to aid the mobile robot in returning thereto.

For example, Prior Art Literature 1 (Korean Patent Publication No. 10-2012-0027544 (published on Mar. 21, 2012) discloses a system for emitting an avoidance signal to prevent accidental contact between a robot and a base station and a system for emitting a return signal for accurately docking a robot device with a base station. The station emitter includes a first signal emitter that emits an avoidance signal and a second signal emitter that emits left and right return signals, and a robot includes a detector to detect signals emitted by the first and second signal emitters.

Prior Art Literature 2 (Korean Patent Publication No. 10-2010-0136904 (published on Dec. 29, 2010)) discloses a docking system that transmits a docking guidance signal such that a first docking guidance area and a second docking guidance area are distinguished depending on the arrival distance of the docking guidance signal. A robot performs docking along the boundary between the first docking guidance area and the second docking guidance area.

Recently, various robots that provide various services have been developed. Additionally, robots that perform cleaning in dry and wet manners are becoming more diverse. Accordingly, the number of users who use multiple mobile robots is increasing. As the number of mobile robots in use increases, the number of stations for charging mobile robots also increases. In this case, if stations are disposed within a certain range, docking signals emitted from the stations may cause interference. In addition, a mobile robot may receive a docking signal emitted from another station while returning to the corresponding station and move to the other station, and thus may not perform an operation of returning to the corresponding station accurately.

Therefore, in a case where a plurality of conventional stations is used as in Prior Art Literature, the stations need to be installed spaced apart, or there are limitations in simultaneously using robot products between adjacent stations.

### DISCLOSURE

### Technical Problem

An object of the present disclosure is to solve the above-described problems and other problems.

An object of the present disclosure is to provide a mobile robot, a docking station, and a robot system including the same which can prevent signal interference.

An object of the present disclosure is to provide a mobile robot, a docking station, and a robot system including the same which can prevent malfunction and accurately dock the mobile robot with the docking station.

An object of the present disclosure is to provide a mobile robot, a docking station, and a robot system including the same which can use a plurality of mobile robots and a plurality of docking stations without collision.

An object of the present disclosure is to provide a mobile robot and a docking station capable of bidirectional communication using power line communication.

An object of the present disclosure is to provide a mobile robot, a docking station, and a robot system including the same which can provide various services related to the mobile robot by communicating with the mobile robot docked with the docking station.

The objects of the present disclosure are not limited to the objects mentioned above, and other objects and advantages of the present disclosure that are not mentioned can be understood through the detailed description according to the embodiments of the present disclosure.

### Technical Solution

In order to achieve the above or other objects, a mobile robot, a docking station, and a robot system including the same according to an aspect of the present disclosure can prevent malfunction and accurately dock the mobile robot with the docking station by performing control such that docking signal transmissions of docking stations do not overlap.

In order to achieve the above or other objects, a mobile robot, a docking station, and a robot system including the same according to an aspect of the present disclosure can perform bidirectional communication using power line communication and provide various services.

In order to achieve the above or other objects, a mobile robot according to an aspect of the present disclosure may include a main body, a communication unit configured to receive, from a server, docking signal information including identification information of a matching docking station to be docked with among a plurality of registered docking stations, a docking signal reception unit configured to receive a docking signal transmitted from at least one of the plurality of docking stations, and a traveling unit configured to move the main body to the matching docking station according to a docking signal transmitted from the matching docking station.

The docking signal information may further include reference time information for synchronizing time information with the matching docking station, and docking signal transmission time information of the matching docking station.

The docking signal transmission time information may include information on a docking signal transmission order of the matching docking station among the plurality of registered docking stations, or information on a difference between the reference time information and a time to transmit the docking signal by the matching docking station.

In order to achieve the above or other objects, the mobile robot according to an aspect of the present disclosure may transmit the docking signal information received from the server to the matching docking station in a state in which the mobile robot has docked with the matching docking station.

In order to achieve the above or other objects, the mobile robot according to an aspect of the present disclosure may further include a power line communication unit configured to transmit the docking signal information to the matching docking station through a charging cable through which power for charging a battery is supplied from the matching docking station.

The power line communication unit may include a transmission unit including a mixer for mixing a serial communication signal with a carrier signal to generate an on-off keying (OOK) modulated transmission signal, and a capacitor disposed between the mixer and the charging cable, and a reception unit including an operational amplifier (OP-AMP), an RC filter connected to a first terminal of the operational amplifier, an envelope detection unit connected to a second terminal of the operational amplifier, and a capacitor connected to the RC filter and the envelope detection unit.

In order to achieve the above or other objects, the mobile robot according to an aspect of the present disclosure may further include an IR light emitting unit configured to output an IR signal to transmit the docking signal information to the matching docking station.

In order to achieve the above or other objects, the mobile robot according to an aspect of the present disclosure may further include a control unit configured to delete docking signals transmitted from docking stations other than the matching docking station among docking signals received through the docking signal reception unit and to control the mobile robot such that the mobile robot travels according to the docking signal transmitted from the matching docking station.

In order to achieve the above or other objects, a docking station according to an aspect of the present disclosure may include a charging terminal electrically connected to a terminal of a mobile robot, a memory in which docking signal information including identification information assigned by a server is stored, a charging unit configured to supply power to charge a battery of the mobile robot through a charging cable, and a signal transmission unit configured to output a docking signal according to the stored docking signal information.

The docking signal information may further include reference time information for synchronizing time information with the mobile robot, and transmission time information of the docking signal.

The transmission time information of the docking signal may include information on an order in which the docking signal is transmitted among a plurality of docking stations registered in the server, or information on a difference between the reference time information and a time to transmit the docking signal.

In order to achieve the above or other objects, the docking station according to an aspect of the present disclosure may receive the docking signal information from the mobile robot in a state in which the mobile robot has docked.

In order to achieve the above or other objects, the docking station according to an aspect of the present disclosure may further include a power line communication unit configured to receive the docking signal information through the charging cable.

The power line communication unit may include a transmission unit including a mixer for mixing a serial communication signal with a carrier signal to generate an OOK modulated transmission signal, and a capacitor disposed between the mixer and the charging cable, and a reception unit including an operational amplifier (OP-AMP), an RC filter connected to a first terminal of the operational amplifier, an envelope detection unit connected to a second terminal of the operational amplifier, and a capacitor connected to the RC filter and the envelope detection unit.

In order to achieve the above or other objects, the docking station according to an aspect of the present disclosure may further include an IR light reception unit configured to receive an IR signal including the docking signal information.

The signal transmission unit may include an IR light emitting unit configured to output the docking signal.

The signal transmission unit may periodically output the docking signal according to the stored docking signal information.

In order to achieve the above or other objects, a robot system according to an aspect of the present disclosure may include a plurality of mobile robots, a plurality of docking stations, and a server configured to assign identification information and docking signal transmission times to a plurality of registered docking stations and to transmit docking signal information including the identification information and the docking signal transmission times to the plurality of mobile robots corresponding to the plurality of docking stations.

The plurality of mobile robots may transfer the docking signal information received from the server to docking stations with which the mobile robots have docked.

The plurality of docking stations may transmit docking signals such that transmission times do not overlap according to the received docking signal information.

### Advantageous Effects

According to at least one of the embodiments of the present disclosure, it is possible to provide a mobile robot, a docking station, and a robot system including the same which can prevent signal interference.

Additionally, according to at least one of the embodiments of the present disclosure, it is possible to prevent malfunction and accurately dock a mobile robot with a docking station.

Additionally, according to at least one of the embodiments of the present disclosure, it is possible to use a plurality of mobile robots and a plurality of docking stations without collision.

Additionally, according to at least one of the embodiments of the present disclosure, a mobile robot and a docking station are capable of bidirectional communication using power line communication. Accordingly, it is possible to provide various services to customers.

In addition, according to at least one of the embodiments of the present disclosure, it is possible to provide a mobile robot, a docking station, and a robot system including the same which can provide various services related to the mobile robot by communicating with the mobile robot docked with the docking state.

### DESCRIPTION OF DRAWINGS

FIG. 1 is a perspective view showing a mobile robot according to an embodiment of the present disclosure.

FIG. 2 is a side view of the mobile robot of FIG. 1.

FIG. 3 is a block diagram showing a control relationship between major components of the mobile robot according to an embodiment of the present disclosure.

FIG. 4 is a perspective view showing a mobile robot and a docking station according to an embodiment of the present disclosure.

FIG. 5 (a) to (c) is a diagram referenced in description of the docking station according to an embodiment of the present disclosure.

FIG. 6 is an internal block diagram of the docking station according to an embodiment of the present disclosure.

FIG. 7 is a diagram referenced in description of docking signal transmission from the docking station.

FIG. 8 is a flowchart showing a method of operating the mobile robot according to an embodiment of the present disclosure.

FIG. 9 is a flowchart showing a method of operating the docking station according to an embodiment of the present disclosure.

FIG. 10 is a flowchart showing a method of operating a robot system according to an embodiment of the present disclosure.

FIG. 11 is a block diagram showing a control relationship between major components related to charging and communication in the mobile robot and the docking station according to an embodiment of the present disclosure.

FIG. 12 is a diagram referenced in description of communication of a robot system according to an embodiment of the present disclosure.

FIGS. 13 and 14 are diagrams referenced in description of docking signal reception and transmission of the robot system according to an embodiment of the present disclosure.

FIG. 15 is a flowchart showing a method of operating a mobile robot according to an embodiment of the present disclosure.

### BEST MODE

Hereinafter, embodiments of the present disclosure will be described in detail with reference to the attached drawings. However, the present disclosure is not limited to these embodiments and can be modified into various forms.

In the drawings, parts not related to description are omitted in order to clearly and briefly describe the present disclosure, and identical or extremely similar parts are denoted by the same reference numerals throughout the specification.

Meanwhile, the suffixes “module” and “part” for components used in the following description are simply given in consideration of the ease of writing this specification and do not give any particularly important meaning or role. Accordingly, the terms “module” and “unit” may be used interchangeably.

Additionally, in this specification, terms such as “first” and “second” may be used to describe various elements, but these elements are not limited by these terms. Such terms are used only to distinguish one element from another.

A control configuration of the present disclosure may include at least one processor.

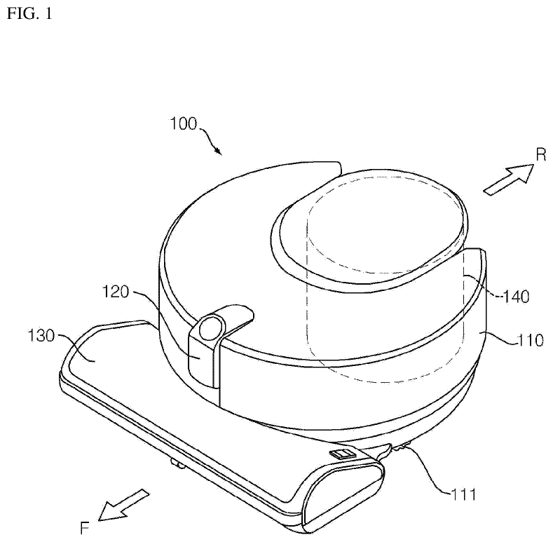

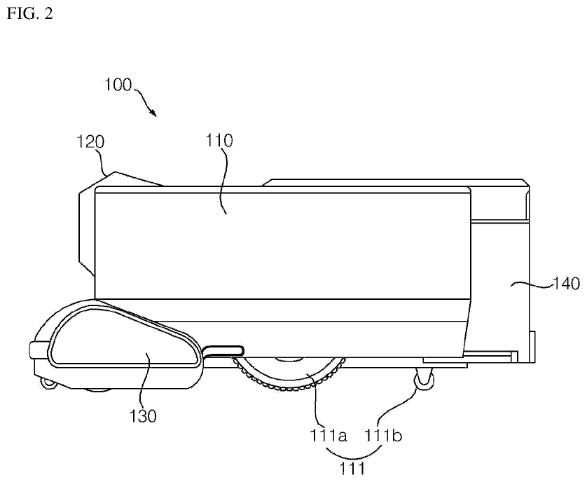

FIG. 1 is a perspective view showing a mobile robot according to an embodiment of the present disclosure, and FIG. 2 is a side view of the mobile robot of FIG. 1.

Referring to FIGS. 1 and 2, the mobile robot 100 can travel a certain area autonomously. The mobile robot 100 can perform a function of cleaning the floor. Floor cleaning mentioned here includes sucking in dust (including foreign substances) from the floor or mopping the floor.

The mobile robot 100 includes a main body 110. The main body 110 includes a cabinet that forms the exterior. The mobile robot 100 may include a cleaning unit 130 and a dust bin 140 provided in the main body 110. The mobile robot 100 includes an image acquisition unit 120 that detects information related to the environment around the mobile robot. The mobile robot 100 includes a traveling unit 160 that moves the main body. The mobile robot 100 includes a control unit 150 for controlling the mobile robot 100. The control unit 150 is provided in the main body 110.

The traveling unit 160 includes a wheel unit 111 for traveling of the mobile robot 100. The wheel unit 111 is provided in the main body 110. The mobile robot 100 can move forward, left, right, or rotate by the wheel unit 111. As the control unit controls driving of the wheel unit 111, the mobile robot 100 can autonomously travel on the floor. The wheel unit 111 includes main wheels 111a and a sub wheel 111b.

The main wheels 111a are provided on both sides of the main body 110 and configured to be able to rotate in one direction or the other direction according to a control signal from the control unit. The main wheels 111a may be configured to be driven independently of each other. For example, the main wheels 111a may be driven by different motors.

The sub wheel 111b supports the main body 110 together with the main wheels 111a and assists traveling of the mobile robot 100 by the main wheels 111a. The sub-wheel 111b may also be provided in a cleaning unit 130 which will be described later.

The cleaning unit 130 may be disposed to protrude from the front F of the main body 110. The cleaning unit 130 may be provided to suck air containing dust.

The cleaning unit 130 may have a shape that protrudes from the front of the main body 110 to both left and right sides. The front end of the cleaning unit 130 may be disposed at a position spaced forward from one side of the main body 110. Both the left and right ends of the cleaning unit 130 may be disposed at positions spaced apart from the main body 110 on both the left and right sides.

The main body 110 is formed in a circular shape, and as both sides of the rear end of the cleaning unit 130 protrude from the main body 110 to the left and right, an empty space, that is, a gap, may be formed between the main body 110 and the cleaning unit 130. The empty space is a space between the left and right ends of the main body 110 and the left and right ends of the cleaning unit 130 and has a shape recessed into the inside of the mobile robot 100.

The cleaning unit 130 may be detachably coupled to the main body 110. When the cleaning unit 130 is separated from the main body 110, a mop module (not shown) may be detachably coupled to the main body 110 to replace the separated cleaning unit 130.

The image acquisition unit 120 may be disposed in the main body 110. The image acquisition unit 120 may be disposed in the front F of the main body 110. The image acquisition unit 120 may be disposed to overlap the cleaning unit 130 in the vertical direction of the main body 110. The image acquisition unit 120 may be disposed at the top of the cleaning unit 130.

The image acquisition unit 120 can detect obstacles around the mobile robot 100. The image acquisition unit 120 can detect obstacles or features in front such that the cleaning unit 130 located at the front of the mobile robot 100 does not collide with obstacles. In addition to this detection function, the image acquisition unit 120 may additionally perform other sensing functions which will be described later.

The main body 110 may be provided with a dust bin container (not shown). The dust bin 140 that separates and collects dust from the sucked air is detachably coupled to the dust bin container. The dust bin container may be formed at the rear R of the main body 110. A part of the dust bin 140 may be accommodated in the dust bin container, and the other part of the dust bin 140 may be formed to protrude to the rear R of the main body 110.

An inlet (not shown) through which air containing dust flows in and an outlet (not shown) through which air from which dust has been separated is discharged are formed in the dust bin 140. The inlet and the outlet of the dust bin 140 are formed to communicate with a first opening (not shown) and a second opening (not shown) formed on the inner wall of the dust bin container when the dust bin 140 is set in the dust bin container.

A suction passage (not shown) is provided to guide air from a suction port of the cleaning unit 130 to the first opening. An exhaust passage (not shown) is provided to guide air from the second opening to an exhaust port (not shown) open to the outside.

Air containing dust introduced through the cleaning unit 130 passes through the suction passage inside the main body 110, flows into the dust bin 140, and is separated from the dust while passing through a filter or cyclone of the dust bin 140. The dust is collected in the dust bin 140, and the air is discharged from the dust bin 140, passes through the exhaust passage inside the main body 110, and is finally discharged to the outside through the exhaust port.

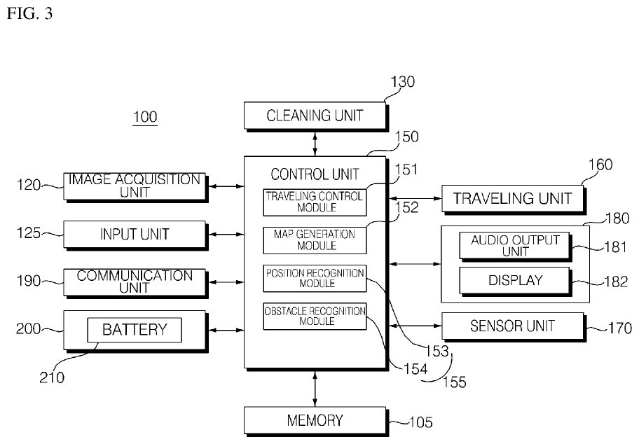

FIG. 3 is a block diagram showing a control relationship between main components of the mobile robot according to an embodiment of the present disclosure.

Referring to FIGS. 1 to 3, the mobile robot 100 includes the main body 110 and the image acquisition unit 120 that acquires images around the main body 110.

The mobile robot 100 includes the traveling unit 160 that moves the main body 110. The traveling unit 160 includes at least one wheel unit 111 that moves the main body 110. The traveling unit 160 includes a driving motor (not shown) that is connected to the wheel unit 111 to rotate the wheel unit 111.

The image acquisition unit 120 captures an image of a traveling area and may include a camera module. The camera module may include a digital camera. A digital camera may include an image sensor (e.g., a CMOS image sensor) that includes at least one optical lens and a plurality of photodiodes (e.g., pixels) that form an image by light passing through the optical lens, and a digital signal processor (DSP) that constructs an image based on signals output from the photodiodes. The digital signal processor can generate not only still images but also moving images composed of frames composed of still images.

Multiple cameras may be installed in each area for image-capturing efficiency. Images captured by the camera can be used to recognize the type of material such as dust, hair, and floor present in the corresponding space and to determine whether cleaning has been performed or a cleaning time.

The camera can capture situations of obstacles or cleaning areas in front of the mobile robot 100 in the traveling direction.

According to an embodiment of the present disclosure, the image acquisition unit 120 may acquire a plurality of images by continuously capturing the surroundings of the main body 110, and the plurality of acquired images may be stored in a memory 105.

The mobile robot 100 can improve the accuracy of spatial recognition, position recognition, and obstacle recognition by using the plurality of images, or select one or more images from the plurality of images and use effective data to improve the accuracy of spatial recognition, position recognition, and obstacle recognition.

Additionally, the mobile robot 100 may include a sensor unit 170 that includes sensors for sensing various types of data related to the operation and state of the mobile robot 100.

For example, the sensor unit 170 may include an obstacle detection sensor that detects an obstacle in front. Additionally, the sensor unit 170 may further include a cliff detection sensor that detects presence of a cliff on the floor within the traveling area and a bottom camera sensor that acquires an image of the floor.

The obstacle detection sensor may include an infrared sensor, an ultrasonic sensor, an RF sensor, a geomagnetic sensor, a position sensitive device (PSD) sensor, etc.

Meanwhile, the positions and types of sensors included in the obstacle detection sensor may depend on the type of the mobile robot, and the obstacle detection sensor may include more diverse sensors.

Meanwhile, the sensor unit 170 may further include a motion detection sensor that detects the motion of the mobile robot 100 according to driving of the main body 110 and outputs motion information. For example, a gyro sensor, a wheel sensor, an acceleration sensor, and the like may be used as a motion detection sensor.

The gyro sensor detects a rotation direction and a rotation angle when the mobile robot 100 moves in a driving mode. The gyro sensor detects the angular velocity of the mobile robot 100 and outputs a voltage value proportional to the angular velocity. The control unit 150 calculates a rotation direction and a rotation angle using the voltage value output from the gyro sensor.

The wheel sensor is connected to the wheel unit 111 and detects the rotation speed of the wheel. Here, the wheel sensor may be a rotary encoder.

The acceleration sensor detects changes in the speed of the mobile robot 100, for example, changes in the mobile robot 100 due to starting, stopping, changing directions, and colliding with an object.

Additionally, the acceleration sensor may be built into the control unit 150 and can detect changes in the speed of the mobile robot 100.

The control unit 150 may calculate a change in the position of the mobile robot 100 on the basis of motion information output from the motion detection sensor. This position is a relative position corresponding to an absolute position using image information. The mobile robot 100 can improve the performance of position recognition using image information and obstacle information through such relative position recognition.

Meanwhile, the mobile robot 100 may include a power supply unit 200 that has a rechargeable battery 210 and supplies power to the mobile robot.

The power supply unit 200 supplies driving power and operating power to each component of the mobile robot 100, and when the remaining power is insufficient, can be charged by receiving power from a docking station 40.

The mobile robot 100 may further include a battery detection unit (not shown) that detects a charging state of the battery 210 and transmits the detection result to the control unit 150. The battery 210 is connected to the battery detection unit and the remaining battery capacity and charging state are transmitted to the control unit 150. The remaining battery capacity may be displayed on a display 182 of an output unit 180.

Additionally, the mobile robot 100 includes an input unit 125 through which on/off or various commands can be input. The input unit 125 may include buttons, dials, a touchscreen, and the like. The input unit 125 may include a microphone for receiving voice instructions from a user. Various control commands necessary for the overall operation of the mobile robot 100 can be input through the input unit 125.

Additionally, the mobile robot 100 includes the output unit 180 which can display reservation information, a battery status, an operation mode, an operation status, an error status, and the like as images or output the same as sound.

The output unit 180 may include an audio output unit 181 that outputs an audio signal. The audio output unit 181 may output warning sound, notification messages such as an operation mode, an operation status, and an error status, and the like through sound under the control of the control unit 150. The audio output unit 181 can convert an electrical signal from the control unit 150 into an audio signal and output the audio signal. To this end, a speaker and the like may be provided.

In addition, the output unit 180 may further include the display 182 that displays reservation information, a battery status, an operation mode, an operation status, an error status, and the like as images.

Referring to FIG. 3, the mobile robot 100 includes the control unit 150 that processes and determines various types of information such as recognizing the current position, and the memory 105 that stores various types of data. Additionally, the mobile robot 100 may further include a communication unit 190 that transmits/receives data to/from an external terminal.

The external terminal may include an application for controlling the mobile robot 100, display a map of traveling areas to be cleaned by the mobile robot 100 through execution of the application, and designate a specific area which will be cleaned on the map. Examples of the external terminal include a remote controller, a PDA, a laptop computer, a smartphone, and a tablet in which an application for map settings is installed.

The external terminal can communicate with the mobile robot 100 and display the current position of the mobile robot along with the map, and may display information on a plurality of areas. Additionally, the external terminal updates and displays the position of the mobile robot as the mobile robot travels.

The control unit 150 controls the overall operation of the mobile robot 100 by controlling the image acquisition unit 120, the input unit 125, the traveling unit 160, the cleaning unit 130, and the like which constitute the mobile robot 100.

The control unit 150 may process a voice input signal of a user received through the microphone of the input unit 125 and perform a voice recognition process. According to the embodiment, the mobile robot 100 may include a voice recognition module that performs voice recognition inside or outside the control unit 150.

According to the embodiment, simple voice recognition may be performed by the mobile robot 100 itself, and higher-level voice recognition such as natural language processing may be performed by a server 90.

The memory 105 records various types of information necessary to control the mobile robot 100 and may include a volatile or non-volatile recording medium. A recording medium stores data that can be read by a microprocessor.

Further, a map of traveling areas may be stored in the memory 105. The map may be input by an external terminal or a server that can exchange information with the mobile robot 100 through wired or wireless communication, or may be generated by the mobile robot 100 through self-learning.

The map may display positions of rooms within traveling areas. Additionally, the current position of the mobile robot 100 may be displayed on the map, and the current position of the mobile robot 100 on the map may be updated during a traveling process. The external terminal stores the same map as the map stored in the memory 105.

The memory 105 may store cleaning history information. Such cleaning history information may be generated each time cleaning is performed.

The map of traveling areas stored in the memory 105 may include a navigation map used for traveling during cleaning, a simultaneous localization and mapping (SLAM) map used for position recognition, a learning map in which, when the mobile robot collides with an obstacle, information on the collision is stored to be used during learning cleaning, a global position map used for global position recognition, an obstacle recognition map in which information on recognized obstacles is recorded, and the like.

Meanwhile, although maps can be stored and managed separately in the memory 105 according to purposes, as described above, maps may not be clearly divided by purposes. For example, a plurality of pieces of information may be stored in one map such that the map can be used for at least two purposes.

The control unit 150 may include a traveling control module 151, a map generation module 152, a position recognition module 153, and an obstacle recognition module 154.

Referring to FIGS. 1 to 3, the traveling control module 151 controls traveling of the mobile robot 100 and controls driving of the traveling unit 160 according to travel settings. Additionally, the traveling control module 151 can ascertain a traveling route of the mobile robot 100 on the basis of the operation of the traveling unit 160. For example, the traveling control module 151 can ascertain the current or past moving speed and distance traveled by the mobile robot 100 on the basis of the rotation speed of the wheel unit 111, and the position of the mobile robot 100 can be updated on the map on the basis of traveling information of the mobile robot 100 ascertained in this manner.

The map generation module 152 can generate a map of traveling areas. The map creation module 152 can create a map by processing images acquired through the image acquisition unit 120. That is, the map generation module 152 can create a cleaning map corresponding to cleaning areas.

In addition, the map generation module 152 can process images acquired through the image acquisition unit 120 at each position and associate the images with the map to recognize the global position.

The position recognition module 153 estimates and recognizes the current position. The position recognition module 153 can ascertain the position in association with the map generation module 152 using image information of the image acquisition unit 120, thereby estimating and recognizing the current position even when the position of the mobile robot 100 suddenly changes.

Additionally, the position recognition module 153 can recognize attributes of the area in which the mobile robot is currently located. That is, the position recognition module 153 can recognize a space.

The mobile robot 100 can recognize the position thereof during continuous traveling through the position recognition module 153, create a map and estimate the current position through the map generation module 152 and the obstacle recognition module 154 without the position recognition module 153.

While the mobile robot 100 is traveling, the image acquisition unit 120 acquires images around the mobile robot 100. Hereinafter, an image acquired by the image acquisition unit 120 is defined as an “acquired image”.

An acquired image includes various features such as lights located on the ceiling, edges, corners, blobs, and ridges.

The map generation module 152 detects features from each acquired image and calculates a descriptor based on each feature point.

The map generation module 152 may classify at least one descriptor for each acquired image into a plurality of groups according to a predetermined sub-classification rule on the basis of descriptor information obtained through acquired images at each position, and convert descriptors included in the same group into sub-representative descriptors according to a predetermined sub-representative rule.

As another example, all descriptors collected from acquired images in a predetermined area, such as a room, may be classified into a plurality of groups according to the predetermined sub-classification rule, and descriptors included in the same group may be converted into sub-representative descriptors according to the predetermined sub-representative rule.

The map generation module 152 can obtain a feature distribution of each position through this process. Each position feature distribution can be represented as a histogram or an n-dimensional vector. As another example, the map generation module 152 may estimate an unknown current position on the basis of a descriptor calculated from each feature point without going through the predetermined sub-classification rule and the predetermined sub-representative rule.

Additionally, in a case where the current position of the mobile robot 100 becomes unknown due to a position jump or the like, the current position can be estimated on the basis of data such as pre-stored descriptors or sub-representative descriptors.

The mobile robot 100 acquires an acquired image through the image acquisition unit 120 at an unknown current position. Various features such as lights located on the ceiling, edges, corners, blobs, and ridges are confirmed through the image.

The position recognition module 153 detects features from the acquired image and calculates a descriptor.

The position recognition module 153 converts the features into information (sub-recognition feature distribution) that can be compared with position information (e.g., feature distribution of each position) to be compared according to a predetermined sub-conversion rule on the basis of at least one piece of recognition descriptor information obtained through the acquired image of the unknown current position.

According to a predetermined sub-comparison rule, each position feature distribution can be compared with each recognition feature distribution to calculate each similarity. Similarity (probability) is calculated for each position, and the position with the highest probability can be determined as the current position.

In this manner, the control unit 150 can divide traveling areas and create a map consisting of a plurality of areas, or recognize the current position of the main body 110 on the basis of a pre-stored map.

When a map is created, the control unit 150 may transmit the generated map to an external terminal, a server, or the like through the communication unit 190. Additionally, as described above, when a map is received from an external terminal, a server, or the like, the control unit 150 can store the map in the memory 105.

In this case, the map may include a cleaning area divided into a plurality of areas, connecting passages connecting the plurality of areas, and information on obstacles within the areas.

When a cleaning command is input, the control unit 150 determines whether the current position of the mobile robot matches the position on the map. The cleaning commands may be input through a remote controller, the input unit, or the external terminal.

If the current position does not match the position on the map or the current position cannot be confirmed, the control unit 150 may recognize the current position, restore the current position of the mobile robot 100, and then control the traveling unit 160 such that the mobile robot 100 moves to a designated area on the basis of the current position.

If the current position does not match the position on the map or the current position cannot be confirmed, the position recognition module 153 may analyze the acquired image input from the image acquisition unit 120 and estimate the current position on the basis of the map. Further, the obstacle recognition module 154 or the map generation module 152 can also recognize the current position in the same manner.

After recognizing the position and restoring the current position of the mobile robot 100, the traveling control module 151 calculates a traveling route from the current position to a designated area and controls the traveling unit 160 such that the mobile robot moves to the designated area.

When cleaning pattern information is received from a server, the traveling control module 151 may divide the entire traveling area into a plurality of areas and set one or more areas as a designated area according to the received cleaning pattern information.

Additionally, the traveling control module 151 may calculate a driving route according to the received cleaning pattern information and control the mobile robot to travel along the driving route to perform cleaning.

Upon completion of cleaning of the designated area, the control unit 150 may store the cleaning record in the memory 105.

Additionally, the control unit 150 may transmit the operating status of the mobile robot 100 or the cleaning status to the external terminal or the server at predetermined intervals through the communication unit 190.

Accordingly, the external terminal displays the position of the mobile robot along with the map on the screen of the application being executed and outputs information on the cleaning status on the basis of received data.

The mobile robot 100 according to an embodiment of the present disclosure may move in one direction until an obstacle or wall is detected, and when the obstacle recognition module 154 recognizes an obstacle, determine a traveling pattern such as moving straight or turning according to attributes of the recognized obstacle.

Meanwhile, the control unit 150 may control the mobile robot to travel while avoiding the obstacle in a different pattern on the basis of the attributes of the recognized obstacle. The control unit 150 may control the mobile robot to travel while avoiding the obstacle in a different pattern depending on the attributes of the obstacle, such as a non-hazardous obstacle (general obstacle), a dangerous obstacle, or a movable obstacle.

For example, the control unit 150 may control the mobile robot to detour and avoid a dangerous obstacle while securing a longer safe distance.

Additionally, in the case of a movable obstacle, if the obstacle does not move after a predetermined waiting time, the control unit 150 may control the mobile robot to perform avoidance traveling corresponding to a general obstacle or avoidance traveling corresponding to a dangerous obstacle. Alternatively, if an avoidance traveling pattern corresponding to a movable obstacle is separately set, the control unit 150 may control the mobile robot to travel according to the avoidance traveling pattern corresponding to a movable obstacle.

The mobile robot 100 according to an embodiment of the present disclosure can perform obstacle recognition and avoidance based on machine learning.

The control unit 150 may include the obstacle recognition module 154 that recognizes obstacles pre-learned through machine learning in an input image, and the traveling control module 151 that controls driving of the traveling unit 160 on the basis of attributes of the recognized obstacle.

Although FIG. 3 shows an example in which the plurality of modules 151, 152, 153, and 154 is separately provided in the control unit 160, the present disclosure is not limited thereto.

For example, the position recognition module 153 and the obstacle recognition module 154 may be integrated into one recognizer and configured as one recognition module 155. In this case, the recognizer may be trained using a learning technique such as machine learning, and the trained recognizer may classify input data and recognize attributes of areas, objects, and the like.

According to the embodiment, the map generation module 152, the position recognition module 153, and the obstacle recognition module 154 may be configured as one integrated module.

Hereinafter, an embodiment in which the position recognition module 153 and the obstacle recognition module 154 are integrated into one recognizer and configured as one recognition module 155 will be mainly described, but the position recognition module 153 and the obstacle recognition module 154 can also operate in the same manner when they are separately provided.

The mobile robot 100 according to an embodiment of the present disclosure may include the recognition module 155 that has learned attributes of objects and spaces through machine learning.

Machine learning means that a computer learns from data without a person directly instructing the computer to use logic, and accordingly the computer solves problems on its own.

Deep learning is a method of teaching computers how to think like humans based on an artificial neural network (ANN) for constructing artificial intelligence and is artificial intelligence technology by which a computer learns like humans on its own without humans teaching the computer.

The artificial neural network (ANN) may be implemented in a software form or in a hardware form such as a chip.

The recognition module 155 may include an artificial neural network (ANN) in the form of software or hardware, which has learned attributes of spaces and attributes of objects such as obstacles.

For example, the recognition module 155 may include a deep neural network (DNN) such as a convolutional neural network (CNN), a recurrent neural network (RNN), or a deep belief network (DBN) trained through deep learning.

The recognition module 155 can determine attributes of a space and an object included in input image data on the basis of weights between nodes included in the deep neural network (DNN).

Meanwhile, the traveling control module 151 may control driving of the traveling unit 160 on the basis of the recognized attributes of the space and obstacle.

Meanwhile, the recognition module 155 may recognize attributes of a space and an obstacle included in a selected specific viewpoint image on the basis of data pre-trained through machine learning.

Meanwhile, the memory 105 may store input data for determining attributes of spaces and objects, and data for training the deep neural network (DNN).

The memory 105 may store original images acquired by the image acquisition unit 120 and extracted images obtained by extracting predetermined areas.

Additionally, depending on the embodiment, weights and biases forming the architecture of the deep neural network (DNN) may be stored in the memory 105.

Alternatively, depending on the embodiment, the weights and biases forming the architecture of the deep neural network may be stored in an embedded memory of the recognition module 155.

Meanwhile, the recognition module 155 may perform a learning process using a predetermined image as training data whenever the image acquisition unit 120 acquires an image or extracts a partial area of an image, or perform the learning process after a predetermined number of images or more is obtained.

Alternatively, the mobile robot 100 may receive data related to machine learning from the predetermined server through the communication unit 190.

In this case, the mobile robot 100 may update the recognition module 155 on the basis of the data related to machine learning received from the predetermined server.

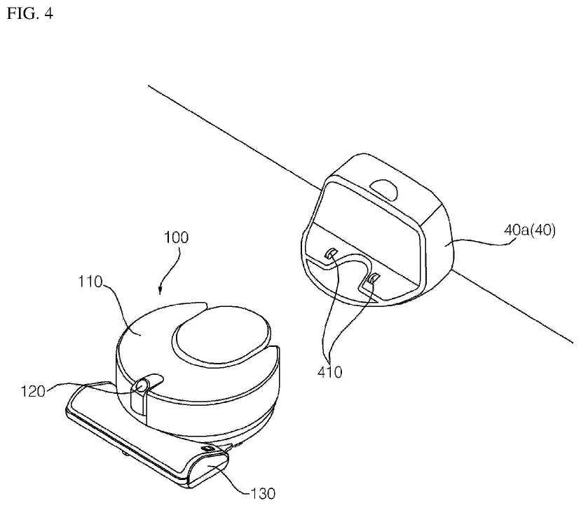

FIG. 4 is a perspective view showing the mobile robot and a docking station according to an embodiment of the present disclosure.

The mobile robot 100 can be docked with the docking station 40 after traveling.

The docking station 40 is electrically connected to a commercial power source. According to the embodiment, the docking station 40 may convert commercial power into power for charging the battery 210 of the mobile robot 100.

The mobile robot 100 is electrically connected to the commercial power source through contact with a charging terminal 410 of the docking station 40 such that the battery 210 can be charged.

The electrical components constituting the mobile robot 100 can receive power from the battery 210. Therefore, when the battery 210 is charged, the mobile robot 100 can travel by itself even when electrically separated from the commercial power source.

Since the docking station 40 provides a function of charging the battery 210 of the mobile robot 100, the docking station 40 may also be called a charging station.

Meanwhile, the docking station 40a illustrated in FIG. 4 provides the function of charging the battery 210 of the docked mobile robot 100.

According to the embodiment, the docking station 40 may provide a function of emptying the dust bin of the mobile robot 100.

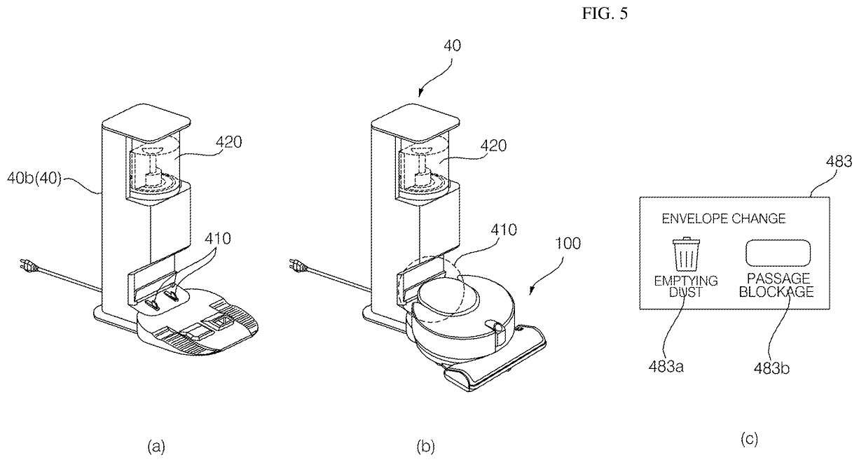

FIG. 5 is a diagram referenced in description of the docking station according to an embodiment of the present disclosure, in which (a) of FIG. 5 is a perspective view of a docking station 40b (40) connected to the commercial power source, (b) of FIG. 5 shows a state in which the mobile robot 100 is docked with the docking station 40b (40), and (c) of FIG. 5 shows a display indicator of the docking station 40b (40).

The docking station 40b illustrated in FIG. 5 provides the function of charging the battery 210 of the docked mobile robot 100 and the function of emptying the dust bin 140 of the mobile robot 100.

The docking station 40b includes a charging terminal 410 and can charge the battery 210 of the mobile robot 100 that is in contact with the charging terminal 410. Additionally, the docking station 40b may perform power line communication with the mobile robot 100 through the charging terminal 410 and a charging cable 600.

The docking station 40b includes a dust collection chamber 420 and a suction motor, and can empty the dust in the dust bin of the docked mobile robot 100 by sucking the dust into the dust collection chamber 420. Additionally, the docking station 40b may further include a door motor that automatically opens and closes a passage door to the dust collection chamber 420.

The docking station 40b may include an output means indicating at least one of a suction motor driving state, a docking state, a charging state, or a charging level. At least one of the suction motor driving state, docking state, charging state, or charging level may be displayed on a display. Alternatively, at least one of the suction motor driving state, docking state, charging state, or charging level may be displayed through lighting, blinking, or color of a lamp.

The docking station 40b may include a pressure sensor capable of detecting dust present in the dust collection chamber 420. The pressure sensor can at least detect whether the dust collection chamber 420 is full of dust.

The docking station 40b may include an indicator 483 related to the dust bin emptying function of the mobile robot 100. The indicator 483 may be disposed on the front of the docking station 40b.

The indicator 483 includes a first indicator 483a that indicates dust bin emptying notification information to guide emptying of dust in the dust collection chamber 420, and a second indicator 483b that indicates blockage of a suction passage of the dust collection chamber 420.

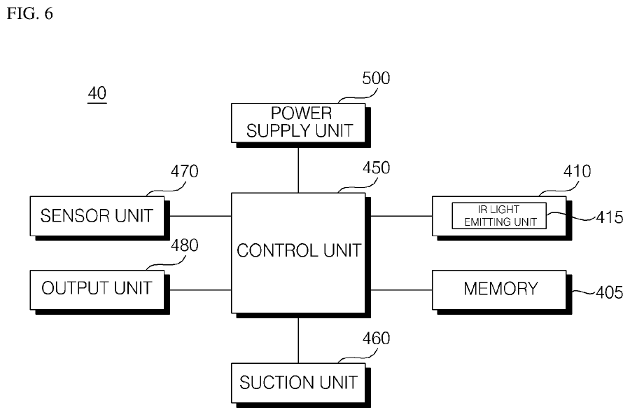

FIG. 6 is an internal block diagram of the docking station according to an embodiment of the present disclosure.

Referring to FIG. 6, the docking station 40 includes a power supply unit 500 that charges the battery 210 of the mobile robot 100, an output unit 480 that outputs status information such as the indicator 483, a sensor unit 470 including one or more sensors, and a control unit 450 that controls the overall operation of the docking station 40.

The power supply unit 500 is connected to the commercial power source and can supply driving power required for operation of the docking station 40 and power for charging the battery 210.

The control unit 450 may control the power supply unit 500 to charge the battery 210 of the docked mobile robot 100. The control unit 450 may be composed of a printed circuit board and elements mounted on the printed circuit board.

The sensor unit 470 may include sensors for sensing various types of data related to the operation and state of the docking station 40.

Meanwhile, the docking station 40b according to an embodiment of the present disclosure may further include a suction unit 460 for emptying the dust bin 140 of the mobile robot 100. The suction unit 460 includes the dust collection chamber 420 for receiving dust therein and a suction motor for sucking dust in the dust bin of the mobile robot 100 into the dust collection chamber 420, and is capable of emptying dust in the internal dust bin of the docked mobile robot 100 by sucking the dust into the dust collection chamber 420.

In addition, the docking station 40b may further include a passage connected to the dust collection chamber 420, a door disposed at the passage, and a door motor that automatically opens and closes the passage door.

Upon determining that the mobile robot 100 is docked, the control unit 450 can operate the door motor to open the passage door of the docking station 40b.

The control unit 450 can operate the suction motor to suck in dust in the dust bin 140. The sucked dust can be contained in the dust collection chamber 420.

The sensor unit 470 may include a sensor that detects dust contained in the dust collection chamber 420. For example, the sensor unit 470 may include a pressure sensor, and the pressure sensor can sense whether the dust collection chamber 420 is full, the amount of dust collected, and the like.

Upon determining that the dust collection chamber 420 needs to be emptied on the basis of sensing data of the sensor unit 470, the control unit 450 may control the first indicator 483a such that the first indicator 483a indicates dust bin emptying notification information for guiding emptying of the dust in the dust collection chamber 420.

Meanwhile, the mobile robot 100 and the docking station 40 may perform power line communication through the charging cable 600. The power supply unit 200 of the mobile robot 100 may perform power line communication under the control of the control unit 150. The power supply unit 500 of the docking station 40 may perform power line communication under the control of the control unit 450. The power supply units 200 and 500 can perform bidirectional communication through power line communication.

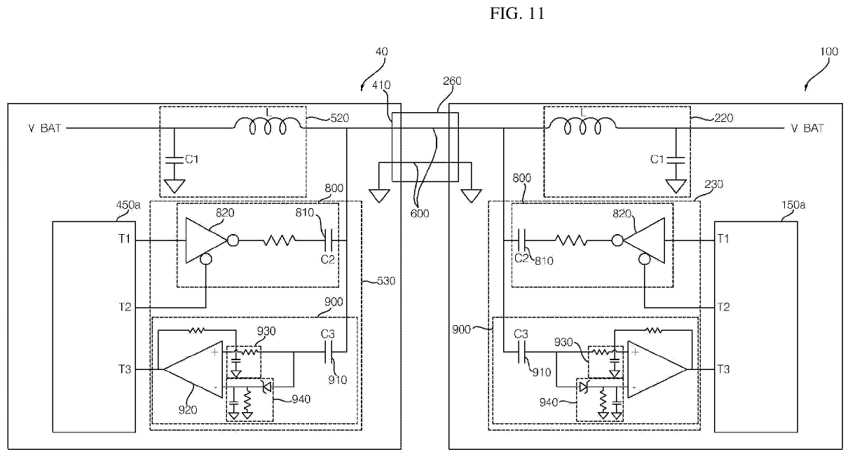

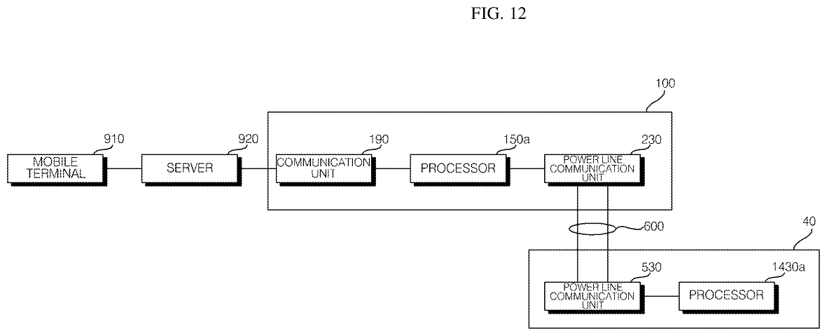

Power line communication will be described in detail later with reference to FIGS. 11 and 12.

Meanwhile, the docking station 40 includes a signal transmission unit 410 that transmits a docking signal to aid the mobile robot 100 in returning. The signal transmission unit 410 may periodically transmit the docking signal under the control of the control unit 450.

Additionally, the mobile robot 100 may receive the docking signal and return to the docking station 40 on the basis of the received docking signal. To this end, the mobile robot 100 includes a docking signal reception means. For example, the docking signal may be an ultrasonic signal or an infrared (IR) signal. If the docking signal is an ultrasonic signal, the mobile robot 100 can detect the docking signal using an ultrasonic sensor of the sensor unit 170. If the docking signal is an IR signal, the mobile robot 100 may include an IR sensor that detects IR signals.

If the docking signal is an IR signal, the mobile robot 100 may include at least an IR light reception unit 145, and the signal transmission unit 410 may include at least an IR light emitting unit 415.

Meanwhile, the docking station 40 includes a memory 405 in which various types of data are stored. The memory 405 records various types of information necessary to control the docking station 40 and may include a volatile or non-volatile recording medium. Data received from the mobile robot 100 may be stored in the memory 405. For example, identification information (ID) assigned to the docking station 40, docking signal transmission time (order) information, and reference time information for time synchronization with the mobile robot 100 and other docking stations 40, and the like may be stored in the memory 405.

Meanwhile, the docking station 40 may include a real time clock (RTC) battery circuit, and may store at least reference time information using the RTC battery circuit function. According to the embodiment, it is also possible to store the ID, IR transmission order, and reference time information using the RTC battery circuit function.

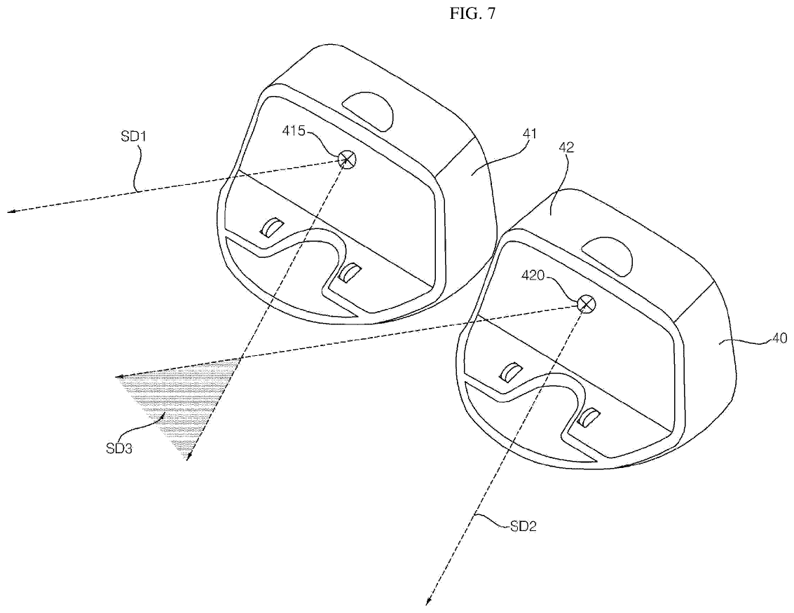

FIG. 7 is a diagram referenced in description of docking signal transmission from the docking station.

Referring to FIG. 7, first and second docking stations 41 and 42 include signal transmission units 415a and 415b that transmit docking signals, respectively. The signal transmission units 415a and 415b may be IR light emitting units 415a and 415b that transmit IR signals.

Meanwhile, the IR light emitting units 415a and 415b may be provided on the sides of the docking stations 41 and 42 and transmit docking signals SD in the direction in which the main body of the mobile robot 100 is docked.

The IR light emitting units 415a and 415b transmit docking signals SD to guide the mobile robot 100 to approach the docking station 41 and 42 to be electrically connected to charging terminals.

The mobile robot 100 to be docked with the first docking station 41 may detect a first docking signal SD1 transmitted by the first IR light emitting unit 415a and perform return traveling to move to the first docking station 41.

However, the mobile robot 100 cannot correctly determine a moving direction in a section in which the first docking signal SD1 transmitted by the first IR light emitting unit 415a and a second docking signal SD2 transmitted by the second IR light emitting unit 415b overlap and thus may malfunction.

Additionally, while moving to the first docking station 41, the mobile robot 100 may change the traveling direction upon detection of the second docking signal SD2 depending on the traveling direction. Further, the mobile robot 100 may wander around without being able to return to the first docking station 41, such as changing the traveling direction again upon detection of the first docking signal SD1.

Therefore, in a case where a plurality of docking stations 41 and 42 is used, a method for effectively preventing signal collision is required.

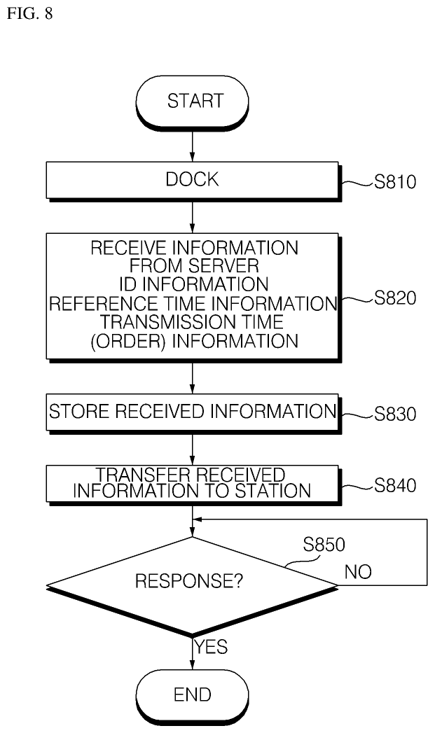

FIG. 8 is a flowchart showing a method of operating the mobile robot according to an embodiment of the present disclosure.

The mobile robot 100 according to an embodiment of the present disclosure may communicate with the server 90 through the communication unit 190. For example, the communication unit 190 may include a Wi-Fi communication module, and the mobile robot 100 and the server 90 can communicate wirelessly using the Wi-Fi communication method.

The mobile robot 100 may receive docking signal information including identification information of a matching docking station with which the mobile robot 100 will dock among a plurality of registered docking stations from the server 90 through the communication unit 190 (S820). In a case where the first and second docking stations 41 and 42 have been registered in the server 90, and the docking station with which the mobile robot 100 will dock is the first docking station 41, the first docking station 41 is a matching docking station 41 for the mobile robot 100.

Meanwhile, the docking signal information may further include reference time information for synchronizing time information with the matching docking station 41, and docking signal transmission time information of the matching docking station 41.

The mobile robot 100 and the matching docking station 41 synchronize their time information according to the received reference time information. Additionally, a plurality of mobile robots 100 and docking stations 40 included in the robot system can also synchronize their time information according to the same reference time information.

Meanwhile, the server 90 may assign identification information (ID) to the plurality of docking stations 41 and 42 registered therein.

Additionally, the server 90 may assign docking signal transmission times for the plurality of registered docking stations 41 and 42 such that docking signal transmissions of the plurality of registered docking stations 41 and 42 do not overlap. Here, the docking signal transmission time may include transmission order information on the order in which the docking stations 41 and 42 transmit docking signals.

Accordingly, the docking signal transmission time information may include docking signal transmission order information of the matching docking station 41 among the plurality of registered docking stations 41 and 42.

Alternatively, the docking signal transmission time information may include information on a difference between the reference time information and the time at which the matching docking station 41 transmits the docking signal. That is, the docking signal transmission time information may include information on how much time elapses from the reference time before the matching docking station 41 transmits the docking signal.

The mobile robot 100 may store the information received from the server 90 in the memory 105 (S830). According to the embodiment, the reference time information and the docking signal transmission time information may be stored using the RTC circuit function.

Meanwhile, the mobile robot 100 may receive the docking signal information from the server 90 in a state in which the mobile robot 100 has docked with the matching docking station 41 (S810).

In addition, in a state in which the mobile robot 100 has docked with the matching docking station 41 (S810), the mobile robot 100 may transmit the docking signal information received from the server 90 to the matching docking station 41 (S840).

The mobile robot 100 and the matching docking station 41 may include power line communication units 230 and 530 for communication through the charging cable 600 through which power for charging the battery 210 is supplied from the matching docking station 41. The mobile robot can transmit the docking signal information to the matching docking station 41 through the power line transmission unit 230.

In another embodiment, the mobile robot 100 may further include an IR light emitting unit (not shown) that outputs an IR signal to transmit the docking signal information to the matching docking station 41.

When a response signal is received from the matching docking station 41 (S850), a registration procedure can be completed. Meanwhile, the mobile robot 100 can complete the registration procedure by sending a signal according to reception of the response signal to the server 90.

Thereafter, the mobile robot 100 may receive a docking signal transmitted from at least one of the plurality of docking stations through a docking signal reception unit 145 during traveling.

At this time, even if the docking signals transmitted by the plurality of docking stations 41 and 42 are received, the control unit 150 knows the time (order) at which the matching docking station 41 transmits the docking signal and thus can identify the docking signal transmitted by the matching docking station 41.

Accordingly, the control unit 150 can delete the docking signal transmitted from the second docking station 42 among the docking signals transmitted from the plurality of docking stations 41 and 42, and control the traveling unit 160 to move the main body 110 to the matching docking station 41 according to the docking signal transmitted from the first docking station 41.

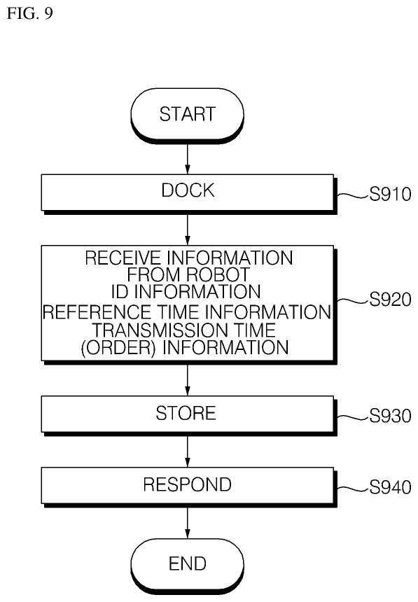

FIG. 9 is a flowchart showing a method of operating the docking station according to an embodiment of the present disclosure.

The docking station 40 (41, 42) according to an embodiment of the present disclosure includes the charging terminal 410 electrically connected to a terminal 260 of the mobile robot 100, the memory 405 in which docking signal information including identification information assigned by the server 90 is stored, a charging unit 520 that supplies power to charge the battery 210 of the mobile robot 100 through the charging cable 600, and the signal transmission unit 410 that outputs a docking signal according to the stored information.

As described above with reference to FIG. 8, the docking signal information may further include reference time information for synchronizing time information with the mobile robot 100, and docking signal transmission time information.

In addition, the docking signal transmission time information may include information on the order in which the plurality of docking stations 40 registered in the server 90 will transmit the docking signal, or information on differences between the reference time information and times to transmit the docking signal.

The docking station 40 may receive the docking signal information from the mobile robot 100 in a state in which the mobile robot 100 has docked thereat (S920).

The docking station 40 includes the power line communication unit 530 and can receive the docking signal information through the charging cable 600.

In another embodiment, the docking station 40 may further include an IR light reception unit (not shown) that receives an IR signal including the docking signal information.

Meanwhile, the docking station 40 may store information received from the mobile robot 100 in the memory 405 (S930). According to the embodiment, the reference time information and the docking signal transmission time information may be stored using the RTC circuit function.

Additionally, the docking station 40 may transmit a response signal to the mobile robot 100 (S840) and complete the registration procedure.

Thereafter, the docking station 40 may output a docking signal according to the transmission time (order) assigned thereto. Additionally, the signal transmission unit 410 may periodically output the docking signal according to the docking signal information. For example, the IR light emitting unit 415 may periodically transmit an IR docking signal on the basis of the received docking signal information.

According to an embodiment of the present disclosure, each docking station 40 may periodically transmit a docking signal to the mobile robot 100 that is paired therewith at a synchronous time independently.

According to an embodiment of the present disclosure, docking signal transmission between adjacent docking stations 40 is set using synchronous time division multiplexing (TDM), thereby enabling efficient docking without collision between adjacent robots 100 and docking stations 40. Accordingly, various differentiated functions for providing customer value can be applied to the robot 100 and docking station 40.

Synchronous time division multiplexing is a method of dividing the bandwidth of one transmission path into time slots and allocating the time slots to channels such that several channels divide and use the time of one transmission path.

Although the docking station 40 does not use a wired transmission line, docking signals transmitted from a plurality of docking stations 40 may overlap or may be adjacent to each other in a predetermined area and thus may affect each other. Accordingly, the time (order) in which the plurality of docking stations 40 transmit docking signals can be divided and allocated such that the docking signals do not overlap.

According to an embodiment of the present disclosure, bidirectional half-duplex communication can be achieved by transmitting and receiving communication signals between the mobile robot 100 and the docking station 40 through the charging terminals 260 and 410 and the charging cable 600.

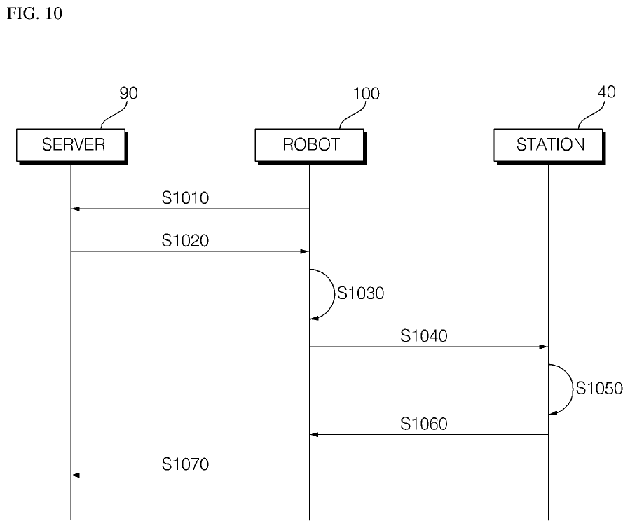

FIG. 10 is a flowchart showing a method of operating a robot system according to an embodiment of the present disclosure.

The robot system according to an embodiment of the present disclosure may include a plurality of mobile robots 100, a plurality of docking stations 40, and the server 90 that assigns identification information and docking signal transmission times to a plurality of registered docking stations 40 and transmits docking signal information including the identification information and the docking signal transmission times to the plurality of mobile robots 100 corresponding to the plurality of docking stations 40.

The mobile robot 100 docked with the docking station 40 may notify the server 90 of docking and request docking signal information (S1010).

The server 90 may transmit docking signal information including identification information of a matching docking station and docking signal transmission time to each mobile robot 100 (S1020).

The mobile robot 100 may store information received from the server 90 (S1030).

Additionally, the mobile robot 100 may transmit the docking signal information received from the server 90 to the matching docking station 40 with which the mobile robot 100 docks (S1040).

Each docking station 40 may store the received docking signal information (S1050) and transmit a response signal to the docked mobile robot 100.

Meanwhile, the mobile robot 100 may transmit a response signal to the server 90 and end the registration procedure (S1070).

Thereafter, the plurality of docking stations 40 may transmit docking signals according to the received docking signal information such that transmission times do not overlap.

Meanwhile, transmission and reception (S1040 and S1060) between the mobile robot 100 and the docking station 40 may be performed through power line communication.

FIG. 11 is a block diagram showing a control relationship between main components related to charging and communication of the mobile robot and the docking station according to an embodiment of the present disclosure.

Referring to FIG. 11, the power supply unit 200 (hereinafter referred to as a first power supply unit) of the mobile robot 100 includes the battery 210 accommodated inside the main body 110, and the charging terminal (260, hereinafter referred to as a first charging terminal) electrically connected to the battery 210.

The power supply unit 500 (hereinafter referred to as a second power supply unit) of the docking station 40 may include the charging terminal (410, hereinafter referred to as a second charging terminal) electrically connected to the first charging terminal 260.

The traveling unit 160 moves the main body 110 containing the battery 210 therein to the docking station 40. The main body 100 includes the first charging terminal 260. As the mobile robot 100 docks with the docking station 40, the first charging terminal 260 of the mobile robot 100 is in contact with the second charging terminal 410 of the docking station 40, and accordingly, the first and second power supply units 200 and 500 can be electrically connected through the charging cable 600.

The first power supply unit 200 includes a charging unit (220, hereinafter referred to as a first charging unit) that receives power from the station 40 through the charging cable 600 and charges the battery 210, and a power line communication unit (230, hereinafter referred to as a first power line communication unit) that performs power line communication with the station 40 through the charging cable 600.

The second power supply unit 500 may also include the same configuration as the first power supply unit 200. The second power supply unit 500 includes a charging unit (520, hereinafter referred to as a second charging unit) that supplies power to charge the battery 210 of the mobile robot 100 through the charging cable 600, and a power line communication unit (530, hereinafter referred to as a second power line communication unit) that performs power line communication with the mobile robot 100 through the charging cable 600.

The docking station 40 may transmit dust collection chamber emptying notification information to the mobile robot 100 through the second power line communication unit 530 on the basis of data detected by the sensor unit 470.

Additionally, the mobile robot 100 may transmit data received from the server 90 or a mobile terminal 910 to the docking station 40 through the first power line communication unit 530.

The second power supply unit 500 may further include a power transform unit (not shown) that transforms commercial power into power for charging the battery 210 of the mobile robot 100.

The mobile robot 100 and the docking station 40 may perform power line communication under the control of processors 150a and 450a, respectively. The processors 150a and 450a may be implemented as some blocks of the control units 150 and 450. Alternatively, the processors 150a and 450a may be provided in the first and second power supply units 200 and 500 separately from the control units 150 and 450. In this case, the processors 150a and 450a may perform power line communication under the control of the control units 150 and 450.

There may be no need for an additional configuration for wireless communication between the mobile robot 100 and the docking station 40 according to power line communication. That is, power is supplied to the battery 210 through the power supply units 200 and 500 and thus the battery 210 can be charged and the mobile robot 100 can be operated, and communication between the mobile robot 100 and the docking station 40 can be achieved through power lines for power supply unit. According to power line communication, a data signal can be modulated into a specific signal (for example, a high-frequency signal) and transmitted through a line for DC power transmission. Power line communication has the advantage of being able to construct a communication network at low cost without installing special additional communication lines by using power lines that have already been secured.

Referring to FIGS. 10 and 11, the first and second power supply units 200 and 500 may include the first and second charging units 220 and 520 and the first and second power line communication units 230 and 530, respectively.

The first and second power line communication units 230 and 530 may include a transmission unit 800 and a reception unit 900.

The transmission unit 800 may include a mixer 820 that mixes a serial communication signal with a carrier signal to generate a transmission signal modulated with on-off keying (OOK), and a capacitor (C2) 810 disposed between the mixer 820 and the charging cable 600. The reception unit 900 can demodulate a received signal modulated with OOK.

On-off keying (OOK) transmits a carrier signal and a data signal simultaneously. At this time, data can be determined based on presence or absence of the carrier signal.

Amplitude shift keying (ASK) determines the amplitude of the carrier signal based on information data. OOK is a modulation method by which bit information of digital data is represented by the presence or absence of a carrier signal, and is one of ASK methods for representing a symbol through changes in amplitude.

For example, OOK may modulate a signal by including a carrier signal in the signal if data is high (e.g., 1) and removing the carrier signal if the data is low (e.g., 0) at the time of transmitting the signal. During demodulation, data can be determined as high if the carrier signal is higher than a reference value, and the data can be determined as low if the carrier signal is lower than the reference value.

Alternatively, OOK may modulate a signal by including a carrier signal in the signal if data is low and removing the carrier signal if the data is high at the time of transmitting the signal. During demodulation, data can be determined as high if the carrier signal is lower than a reference value, and the data can be determined as low if the carrier signal is higher than the reference value.

The mixer 820 may be an OOK modulator that mixes transmission data with a high-frequency (e.g., 10 MHz) carrier signal and modulates the mixed signal. The mixer 820 may generate a transmission signal by mixing a serial communication signal including transmission data with the carrier signal.

The mixer 820 may include a three-state buffer. A 3-state buffer is a buffer with three output levels (high, low, and high impedance (Hi-Z)). High impedance is an open state in which an external input and output are not connected and can prevent elements from being damaged due to circuit collision in a bus structure that connects multiple elements to one line.

According to an embodiment of the present disclosure, the transmission signal generated by the mixer 820 can be output in such a manner that the carrier signal is output only when the serial communication signal is low and the transmission signal is output in the high impedance (High-Z) state when the serial communication signal is high.

Meanwhile, the mobile robot 100 may include the first processor 150a that processes power line communication data, and the docking station 20 may include the second processor 450a that processes power line communication data. The first and second processors 150a and 450a may be microcomputer units (MCUs) that control the power line communication process.

The first and second processors 150a and 450a may generate data for power line communication, extract data from received signals, and determine the data. The first and second processors 150a and 450a may generate the carrier signal and the serial communication signal. The first and second processors 150a and 450a may generate a high-frequency carrier signal and asynchronous serial communication data.

The first and second processors 150a and 450a may include input/output terminals. The first and second processors 150a and 450a may include output terminals T1 and T2. The first and second terminals T1 and T2 are connected to the mixer 820. The first and second processors 150a and 450a output the carrier signal to the mixer 820 through the first terminal T1 and output the serial communication signal to the mixer 820 through the second terminal T1.

A transmission signal (OOK modulated signal) output from the mixer 820 is AC coupled at the capacitor 810 and sent over the charging cable 600. The transmission unit 800 may have an OOK modulation and power line coupling circuit structure in which a UART signal is carried on a high-frequency carrier.

The first and second charging units 220 and 520 may include at least one power inductor L. The first and second charging units 220 and 520 may include an LC filter. The first and second charging units 220 and 520 may include a low-pass filter including at least one inductor L and at least one capacitor C. The LC filter can filter an OOK modulated signal such that that the OOK modulated signal does not pass to the line for charging the battery 210.

In the first charging unit 220, the LC filter L and C1 may be disposed at the front end of the battery 210. In the second charging unit 520, the LC filter L and C1 may be disposed on the line through which a battery voltage V_BAT is applied to the charging terminal 410. For example, the LC filter L and C1 may be disposed between the charging cable 600 and the power transform unit 540.

The charging cable 600 may be composed of two wires: a positive line and a negative line of DC power. A ground GND may be connected to the negative line. The first and second charging units 220 and 520 and the first and second power line communication units 230 and 540 can be connected in parallel to the two wires of the charging cable 600.

During docking, the mobile robot 100 and the docking station 40 are connected by wire using the two-wire charging cable 600. Through the two-wire charging cable 600, a power & communication signal that is a mixture of DC power and an OOK modulated signal is transmitted and received, and DC power supply unit and signal transmission can be performed.

Meanwhile, the reception unit 900 may be connected to a third terminal T3 of the first and second processors 150a and 450a. The reception unit 900 and the transmission unit 800 may be connected in parallel to the charging cable 600.

The reception unit 900 may include an operational amplifier (OP-AMP) 920 connected to the third terminals T3 of the first and second processors 150a and 450a, an RC filter 930 connected to a first terminal (+) of the operational amplifier 920, an envelope detection unit 940 connected to a second terminal (−) of the operational amplifier 920, and a capacitor (C3) 910 connected to the RC filter 930 and the envelope detection unit 940.

The capacitor (C3) 910 can block a DC voltage applied to the reception unit 900.

An envelope change in an amplitude-modulated carrier signal is the same as the waveform of a data signal. Therefore, the data signal can be restored using the envelope detection unit 940.

The RC filter 930 can output a moving average value based on a received signal, and the envelope detection unit 940 can output an envelope detection signal by detecting an envelope in the received signal.

The operational amplifier 920 is a data slicer that restores data from an input signal, and can restore data by comparing the envelope detection signal with another value and outputting the result. For example, the operational amplifier 920 may restore data by comparing the moving average value and the envelope detection signal and outputting a value of “1” or “0” according to the comparison result. The operational amplifier 920 may compare the moving average value and the envelope detection signal and output an inverted signal.

Moving averages have the advantage of smoothing extreme changes and eliminating noise when data changes significantly. The RC filter 930 may be a moving average filter that performs moving averaging of N predetermined values in successively input signals and outputs the results.

The RC filter 930 can extract a moving average value and then input the moving average value to the first terminal (+) of the operational amplifier 920. The envelope detection unit 940 may input an envelope detection signal to the second terminal (−) of the operational amplifier 920 after envelope detection. The operational amplifier 920 can compare inputs and output an inverted output.

According to embodiments of the present disclosure, supply of power for charging the battery 210 and bidirectional data transmission can be performed through the two-wire charging cable 600 between the docking station 40 and the mobile robot 100. Accordingly, there are no variations in the docking stations 40 and the mobile robots 100, and highly reliable communication that does not require calibration can be realized.

FIG. 12 is a diagram referenced in description of communication of a robot system according to an embodiment of the present disclosure.

The robot system according to an embodiment of the present disclosure may include the mobile robot 100 that travels using power stored in the battery 210, and the docking station 40 that charges the battery 210 by supplying power through the charging cable 600.

The mobile robot 100 and the docking station 40 may include the power line communication units 230 and 530 that perform power line communication through the charging cable 600.

Accordingly, the mobile robot 100 and the docking station 40 can charge the battery of the mobile robot 100 and perform bidirectional data communication using the two-wire charging cable 600.

As described above, the power line communication units 230 and 530 may include the transmission unit 800 that includes the mixer 820 that mixes a serial communication signal with a carrier signal to generate an OOK modulated transmission signal and the capacitor 810 disposed between the mixer 820 and the charging cable 600, and the reception unit 900 that includes the operational amplifier 920, the RC filter 930 connected to the first terminal of the operational amplifier 920, an envelope detection unit 940 connected to the second terminal of the operational amplifier 920, and the capacitor 910 connected to the RC filter 930 and the envelope detection unit 940.

The mobile robot 100 may include the first processor 150a that processes power line communication data, and the docking station 20 may include the second processor 450a that processes power line communication data. The first and second processors 150a and 450a may generate data for power line communication, extract data from received signals, and determine the data.

The docking station 40 can perform bidirectional communication with the mobile robot 100, and can communicate with external devices via the mobile robot 100.

The mobile robot 100 can transmit at least one of status information, an update file, a dust bin emptying request signal, or docking signal information to the docking station 40 through power line communication.

The docking station 40 can transmit at least one of status information such as dust collection amount information of the dust collection chamber 420 or a response to a request received from the mobile robot 100 to the mobile robot 100 through power line communication.

According to an embodiment of the present disclosure, the docking station 40 can transmit various types of information such as dust bin emptying notification information and docking signal information to the mobile robot 100 through power line communication, and the mobile robot 100 can transmit various types of information such as dust bin emptying notification information to the predetermined server 90 or the predetermined mobile terminal 910.

According to an embodiment of the present disclosure, firmware can be updated without disassembling the docking station 40.

A user can request firmware update by operating the mobile terminal 910. The server 90 may transmit an update file through the communication unit 190 of the mobile robot 100 using a communication method such as Wi-Fi. The mobile robot 100 can transfer the update file to the docking station 40 through power line communication.

The docking station 40 can update the firmware using the received update file and notify the mobile robot 100 of completion of update through power line communication.

The mobile robot 100 may notify the server 90 and/or the mobile terminal 910 of completion of update through the communication unit 190.

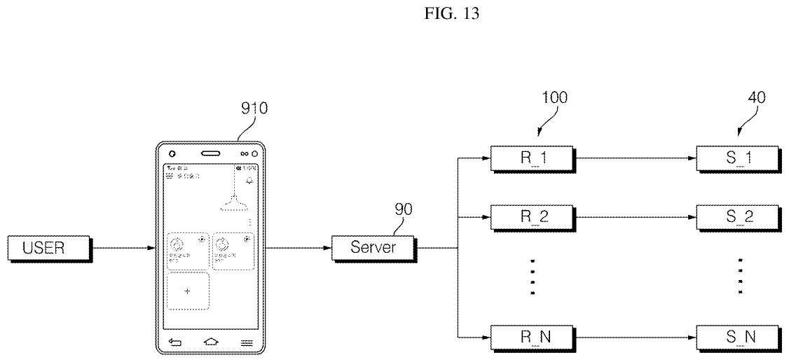

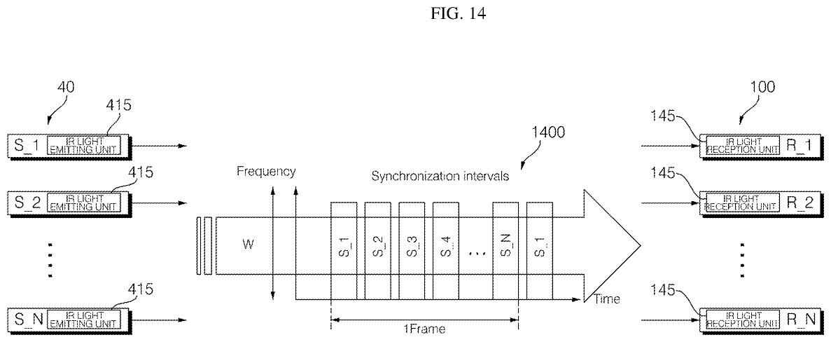

FIGS. 13 and 14 are diagrams referenced in description of docking signal transmission and reception of the robot system according to an embodiment of the present disclosure.

Referring to FIG. 13, the user can register a plurality of robots R_1, R_2, . . . , R_N to be used by operating the mobile terminal 910. The user can register the plurality of robots R_1, R_2, . . . , R_N by executing a robot-related application on the mobile terminal 910. In particular, in a case where matching docking stations S_1, S_2, . . . , S_N corresponding to the plurality of robots R_1, R_2, . . . , R_N are installed adjacently, the user can register robot-station pairs installed adjacently.

Meanwhile, the server 90 can assign identification information (paring ID) and an IR transmission order to the docking stations S_1, S_2, . . . , S_N.

The server 90 can transmit docking signal information and the like through the communication units 190 of the plurality of robots R_1, R_2, . . . , R_N using a communication method such as Wi-Fi. The docking signal information may include IDs, IR transmission order, synchronization time information, and the like.

Meanwhile, the plurality of robots R_1, R_2, . . . , R_N can transfer the docking signal information including IDs, IR transmission order, synchronization time information, and the like to the matching docking stations S_1, S_2, . . . , S_N with which the robots R_1, R_2, . . . , R_N will dock using power line communication.

Meanwhile, the docking stations S_1, S_2, . . . , S_N can store the received docking signal information. According to the embodiment, the docking stations S_1, S_2, . . . , S_N may store the docking signal information in a memory (may store the same using the RTC battery circuit function if the memory is separately provided).

The docking stations S_1, S_2, . . . , S_N can transmit docking signals according to the received docking signal information. The IR light emitting units 415 provided in the docking stations S_1, S_2, . . . , S_N may sequentially transmit IR signals such that the IR signal do not overlap according to the assigned order.

The docking signals 1400 sequentially transmitted by the IR light emitting units 415 of the docking stations S_1, S_2, . . . , S_N may be sequentially assigned at regular intervals within one frame.

Meanwhile, the IR light reception units 145 of the robots R_1, R_2, . . . , R_N can detect all or some of the docking signals 1400.

The robots R_1, R_2, . . . , R_N can identify the docking signals of the docking stations S_1, S_2, . . . , S_N corresponding thereto and travel to dock according to the identified docking signals of the matching docking stations.

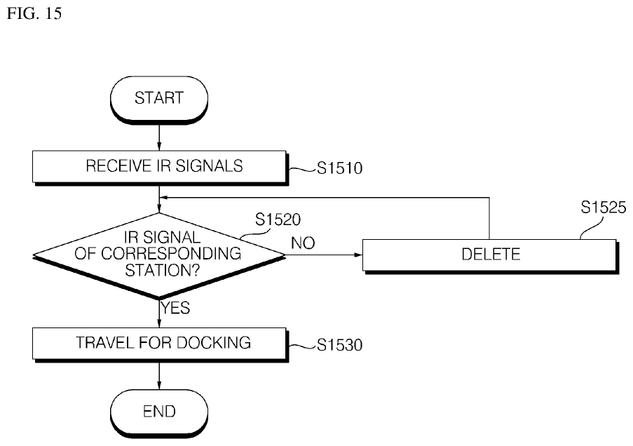

FIG. 15 is a flowchart showing a method of operating a mobile robot according to an embodiment of the present disclosure.

Referring to FIGS. 14 and 15, one mobile robot 100 among the robots R_1, R_2, . . . , R_N can detect all or some of the docking signals transmitted from the plurality of docking stations S_1, S_2, . . . , S_N (S1510).

The control unit 150 can delete IR signals other than the IR signal of the corresponding matching docking station (S1525) and control the mobile robot 100 such that the mobile robot 100 travels to dock on the basis of the IR signal of the corresponding matching docking station (S1530).

The mobile robot, the docking station, and the robot system including the same according to the present disclosure are not limited to the configurations and methods of the embodiments described above, and all or some of the embodiments may be selectively combined such that various modifications can be made.

In addition, although preferred embodiments of the present disclosure have been illustrated and described above, the present disclosure is not limited to the specific embodiments described above and various modifications can be made by those skilled in the art without departing from the gist of the present disclosure as claimed in the claims. Such modifications should not be understood individually from the technical idea or perspective of the present disclosure.

1. A mobile robot comprising:
a main body;
a communication unit configured to receive, from a server, docking signal information including identification information of a matching docking station to be docked with among a plurality of registered docking stations;
a docking signal reception unit configured to receive a docking signal transmitted from at least one of the plurality of docking stations; and
a traveling unit configured to move the main body to the matching docking station according to a docking signal transmitted from the matching docking station.

2. The mobile robot according to claim 1, wherein the docking signal information further includes reference time information for synchronizing time information with the matching docking station, and docking signal transmission time information of the matching docking station.

3. The mobile robot according to claim 2, wherein the docking signal transmission time information includes information on a docking signal transmission order of the matching docking station among the plurality of registered docking stations, or information on a difference between the reference time information and a time to transmit the docking signal by the matching docking station.

4. The mobile robot according to claim 1, wherein the docking signal information received from the server is transmitted to the matching docking station in a state in which the mobile robot has docked with the matching docking station.

5. The mobile robot according to claim 4, further comprising a power line communication unit configured to transmit the docking signal information to the matching docking station through a charging cable through which power for charging a battery is supplied from the matching docking station.

6. The mobile robot according to claim 5, wherein the power line communication unit comprises:
a transmission unit including a mixer for mixing a serial communication signal with a carrier signal to generate an on-off keying (OOK) modulated transmission signal, and a capacitor disposed between the mixer and the charging cable; and
a reception unit including an operational amplifier (OP-AMP), an RC filter connected to a first terminal of the operational amplifier, an envelope detection unit connected to a second terminal of the operational amplifier, and a capacitor connected to the RC filter and the envelope detection unit.

7. The mobile robot according to claim 4, further comprising an IR light emitting unit configured to output an IR signal to transmit the docking signal information to the matching docking station.

8. The mobile robot according to claim 1, further comprising a control unit configured to delete docking signals transmitted from docking stations other than the matching docking station among docking signals received through the docking signal reception unit and to control the mobile robot such that the mobile robot travels according to the docking signal transmitted from the matching docking station.

9. A docking station comprising:
a charging terminal electrically connected to a terminal of a mobile robot;
a memory in which docking signal information including identification information assigned by a server is stored;
a charging unit configured to supply power to charge a battery of the mobile robot through a charging cable; and
a signal transmission unit configured to output a docking signal according to the stored docking signal information.

10. The docking station according to claim 9, wherein the docking signal information further includes reference time information for synchronizing time information with the mobile robot, and transmission time information of the docking signal.

11. The docking station according to claim 10, wherein the transmission time information of the docking signal includes information on an order in which the docking signal is transmitted among a plurality of docking stations registered in the server, or information on a difference between the reference time information and a time to transmit the docking signal.

12. The docking station according to claim 9, wherein the docking station receives the docking signal information from the mobile robot in a state in which the mobile robot has docked.

13. The docking station according to claim 12, further comprising a power line communication unit configured to receive the docking signal information through the charging cable.

14. The docking station according to claim 13, wherein the power line communication unit comprises:
a transmission unit including a mixer for mixing a serial communication signal with a carrier signal to generate an OOK modulated transmission signal, and a capacitor disposed between the mixer and the charging cable; and
a reception unit including an operational amplifier (OP-AMP), an RC filter connected to a first terminal of the operational amplifier, an envelope detection unit connected to a second terminal of the operational amplifier, and a capacitor connected to the RC filter and the envelope detection unit.

15. The docking station according to claim 13, further comprising an IR light reception unit configured to receive an IR signal including the docking signal information.

16. The docking station according to claim 9, wherein the signal transmission unit includes an IR light emitting unit configured to output the docking signal.

17. The docking station according to claim 9, wherein the signal transmission unit periodically outputs the docking signal according to the stored docking signal information.

18. A robot system comprising:
a plurality of mobile robots;
a plurality of docking stations; and
a server configured to assign identification information and docking signal transmission times to a plurality of registered docking stations and to transmit docking signal information including the identification information and the docking signal transmission times to the plurality of mobile robots corresponding to the plurality of docking stations.

19. The robot system according to claim 18, wherein the plurality of mobile robots transfers the docking signal information received from the server to docking stations with which the mobile robots have docked.

20. The robot system according to claim 19, wherein the plurality of docking stations transmits docking signals such that transmission times do not overlap according to the received docking signal information.
